(19) United States
(12) Patent Application Publication
(10) Pub. No.: US 2026/0355777 A1
(43) Pub. Date: Nov. 12, 2026

(54) POWDER DISPERSION APPARATUSES AND SYSTEMS USING CONCENTRIC ROLLERS

(71) Applicant: Soelect Inc., Greensboro, NC (US)

(72) Inventor: Sungjin CHO, Summerfield, NC (US)

(21) Appl. No.: 19/673,561

(22) Filed: May 11, 2026

Related U.S. Application Data
(60) Provisional application No. 63/803,190, filed on May 9, 2025.

(51) Int. Cl. B05C 1/08; B05C 11/02; B05C 21/00

(52) U.S. Cl. CPC B05C 1/0834; B05C 11/023; B05C 21/00

(57) ABSTRACT

The present disclosure provides a powder dispersion apparatus that includes an inner roller comprising a plurality of first powder-passing openings, and an outer roller disposed around the inner roller and comprising a plurality of second powder-passing openings. The inner roller and the outer roller are arranged coaxially about a common axis, the outer roller being spaced from the inner roller to define an annular powder-transfer region. The apparatus further includes a drive mechanism configured to rotate one or both of the inner roller and the outer roller to establish relative rotation between the inner roller and the outer roller. The relative rotation between the inner roller and the outer roller moves powder through the annular powder-transfer region, generates shear within the annular powder-transfer region, and dispenses the powder through the second powder-passing openings of the outer roller.

### CROSS-REFERENCE TO RELATED APPLICATIONS

This application claims priority to U.S. Provisional Patent Application No. 63/803,190, filed May 9, 2025, which is hereby incorporated by reference in its entirety.

### TECHNICAL FIELD

The present disclosure relates to powder coating and powder dispersion, and more particularly to apparatuses and systems for controlled powder dispersion using concentric rollers.

### BACKGROUND

Dry powder coating and dry powder dispersion processes are useful in manufacturing processes that benefit from reduced solvent use, controlled surface modification, and continuous web handling. In battery manufacturing, for example, dry powder processes can reduce or eliminate solvent handling, drying equipment, solvent recovery systems, and associated energy consumption. Dry powder coating can also enable surface treatments or functional layers on substrates for which wet processing may be undesirable.

Conventional powder delivery systems, however, may provide insufficient control over powder flow, powder uniformity, and spatial distribution. For example, single-roll powder applicators, gravity-fed hoppers, fluidized beds, electrostatic spray systems, and brush-based applicators may be susceptible to powder agglomeration, inconsistent feed rates, nonuniform deposition across a substrate width, excessive powder loss, clogging at dispensing apertures, or inadequate control of powder thickness.

These challenges may be particularly significant when functional powders are applied to delicate substrates. Lithium metal foil, for example, may be thin, reactive, mechanically soft, and sensitive to handling conditions. Uneven powder delivery can create local coating defects, poor interfacial contact, nonuniform electrochemical behavior, reduced cycle life, or manufacturing yield loss. At the same time, high-throughput battery manufacturing favors continuous roll-to-roll architectures, compact housings, and components that can be readily cleaned and maintained.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

As indicated above, there remains a need for a powder dispersion apparatus capable of controlling powder feed, de-agglomerating powder, and delivering powder uniformly onto one or more surfaces of a substrate. There is also a need for a roll-to-roll powder coating system that can reduce powder loss, contamination, clogging, and uncontrolled powder accumulation.

In one embodiment, a powder dispersion apparatus is disclosed. The powder dispersion apparatus includes an inner roller comprising a plurality of first powder-passing openings, and an outer roller disposed around the inner roller and comprising a plurality of second powder-passing openings. The inner roller and the outer roller are arranged coaxially about a common axis, wherein the outer roller being spaced from the inner roller to define an annular powder-transfer region. The apparatus further includes a drive mechanism configured to rotate one or both of the inner roller and the outer roller to establish relative rotation between the inner roller and the outer roller. Relative rotation between the inner roller and the outer roller moves powder through the annular powder-transfer region, generates shear within the annular powder-transfer region, and dispenses the powder through the second powder-passing openings of the outer roller.

In one embodiment, a roll-to-roll powder coating system is disclosed. The powder coating system includes a housing configured to maintain a dry or inert atmosphere, a substrate transport path extending through the housing and configured to convey a substrate, a plurality of guide rollers arranged to guide the substrate along the substrate transport path, and a powder dispersion apparatus positioned adjacent to the substrate transport path and configured to dispense powder onto a surface of the substrate. The powder dispersion apparatus comprises an inner roller and an outer roller arranged coaxially about a common axis, the inner roller comprising a plurality of first powder-passing openings, the outer roller comprising a plurality of second powder-passing openings and being spaced from the inner roller to define an annular powder-transfer region. The powder dispersion apparatus is also configured to establish relative rotation between the inner roller and the outer roller to move the powder through the annular powder-transfer region, generate shear within the annular powder-transfer region, and dispense the powder through the second powder-passing openings of the outer roller.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a side view of an example powder coating system including a substrate transport path through a housing according to some embodiments.

FIG. 2 illustrates an example powder dispersion apparatus including an inner roller and an outer roller according to some embodiments.

FIG. 3 illustrates example dimensions and powder-passing opening patterns of an example powder dispersion apparatus according to some embodiments.

FIG. 4 illustrates example dimensions of an inner roller according to some embodiments.

FIG. 5 illustrates example dimensions of an outer roller according to some embodiments.

FIG. 6 illustrates example details of an inner roller and associated ribs, including sectional and end views according to some embodiments.

FIG. 7 is an exploded view of an example powder dispersion apparatus, according to some embodiments.

FIG. 8 is a perspective view of an example powder coating system using one or more powder dispersion apparatuses, according to some embodiments.

FIG. 9 is a graph depicting voltage curves for example electrochemical cells, according to some embodiments.

FIG. 10 is a graph depicting example capacity retention of electrochemical cells, according to some embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes powder dispersion apparatuses and powder coating systems that utilize concentric rollers to dispense powder onto a substrate. As used herein, the terms “powder,” “dry powder,” and “functional powder” include particulate materials that can be dispensed in a substantially dry state. The powder may include particles, aggregates, flakes, fibers, nanostructures, microstructures, or mixtures thereof. The powder may include active materials, electronically conductive materials, ionically conductive materials, ceramic materials, protective additives, binders, polymers, salts, surface modifiers, or processing aids. Moreover, as used herein, the term “substrate” may include a web, foil, film, sheet, tape, membrane, current collector, electrode, separator, polymer film, metal foil (e.g., lithium metal foil), or other article that may receive powder. The substrate may be moved continuously or intermittently through the powder coating system.

In some embodiments, a powder dispersion apparatus includes an inner roller and an outer roller arranged coaxially about a common axis. The inner roller and outer roller include respective powder-passing openings and define an annular powder-transfer region (e.g., gap or space between the two rollers). Relative rotation between the inner roller and the outer roller may move powder through the annular powder-transfer region, generate shear within the annular powder-transfer region, and dispense the powder through powder-passing openings of the outer roller.

The disclosed apparatus may be used in roll-to-roll powder coating systems and processes, including systems in which a substrate is conveyed through a housing along a substrate transport path. In some embodiments, the system is configured to coat a web, foil, film, sheet, membrane, laminate, or other substrate. The powder may be applied to one or more surfaces of the substrate and may be managed using features such as powder brushes, electrostatic charging units, powder collection features, guide rollers, and process controls. In certain embodiments, the substrate includes a metal foil substrate, such as lithium metal foil, and the powder is applied in a dry or inert atmosphere.

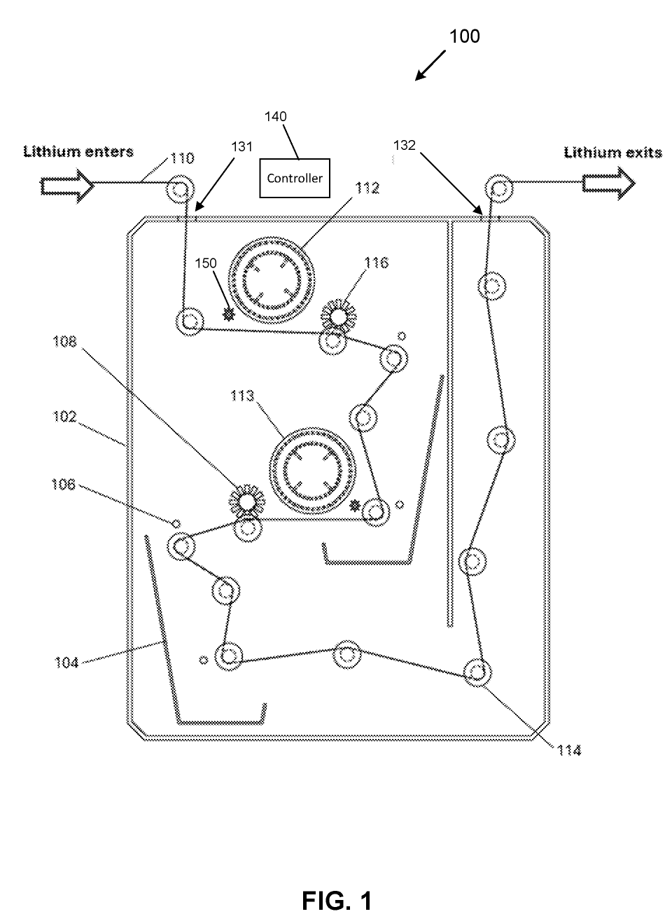

FIG. 1 illustrates an example roll-to-roll powder coating system 100 according to some embodiments. The powder coating system 100 includes a housing 102 defining an enclosure through which a substrate 110 is routed. In the illustrated embodiment, the substrate 110 may be supplied from a roll and may include a lithium-containing substrate, such as lithium metal foil. In other embodiments, the substrate 110 may include another web, foil, film, sheet, membrane, laminate, current collector, electrode, separator, polymer film, metal foil, or other article configured to receive powder.

The substrate 110 enters the housing 102 at a housing inlet 131, travels through the housing 102 along a substrate transport path, and exits the housing 102 at a housing outlet 132. The housing 102 may contain powder during coating and may define an internal coating environment. In some embodiments, the housing 102 may be configured to maintain a dry atmosphere, an inert atmosphere, or another controlled atmosphere (e.g., dry or inert atmosphere) suitable for the substrate 110 and the powder being processed. In some embodiments, the dry atmosphere may have a dew point of about minus 40 degrees Celsius or lower. In some embodiments, the inert atmosphere may include nitrogen, argon, or another inert gas. For example, when the substrate 110 includes lithium metal foil, the housing 102 may be configured to reduce exposure of the substrate 110 and the powder to moisture, oxygen, or other contaminants. In some embodiments, the housing 102 may include one or more access panels, glovebox interfaces, viewing windows, inert-gas ports, dry-room interfaces, purge ports, powder recovery ports, static-dissipative components, grounding connections, pressure control features, humidity control features, oxygen control features, safety interlocks, or combinations thereof.

A plurality of guide rollers 114 are arranged within the housing 102 to guide the substrate 110 along the substrate transport path. The guide rollers 114 may control routing, tension, flatness, dwell time, and positioning of the substrate 110 relative to powder dispensing components (e.g., powder dispersion apparatuses) within the housing 102. In one example, the plurality of guide rollers 114 may include at least sixteen roll-to-roll shaft assemblies arranged to define the substrate transport path and guide the substrate 110 through the housing 102. In some embodiments, the substrate 110 may be moved continuously or intermittently along the substrate transport path. In some embodiments, the guide rollers 114 may define a continuous or intermittent roll-to-roll substrate transport path. The guide rollers 114 may also position different portions of the substrate 110 adjacent to different powder dispersion apparatuses, powder brushes, powder collection features, or other system components.

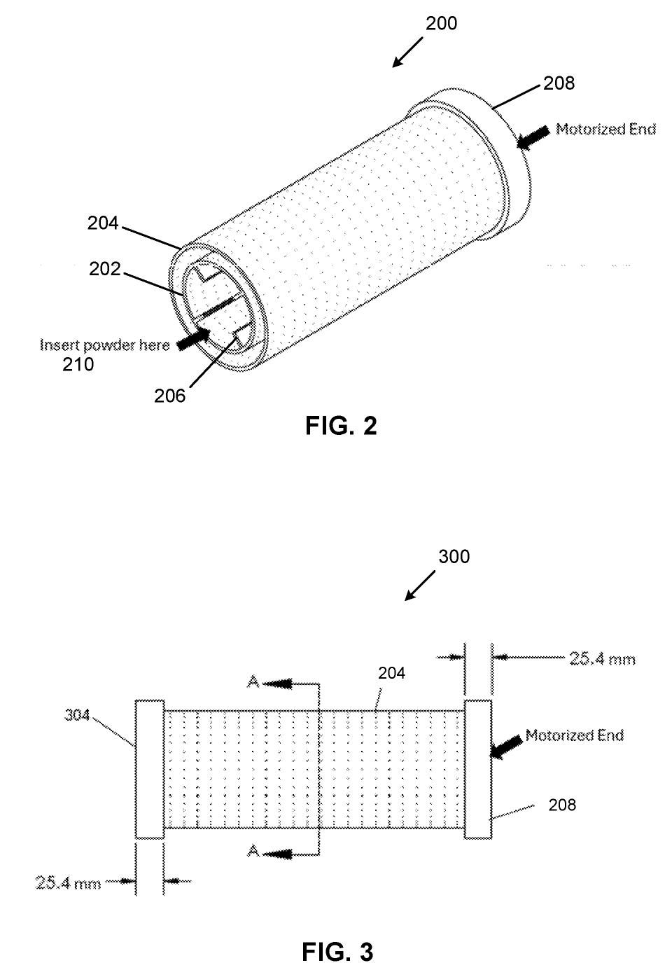

The powder coating system 100 includes a first powder dispersion apparatus 112 positioned adjacent to the substrate transport path. The first powder dispersion apparatus 112 may include an inner roller and an outer roller (as described in greater detail below and illustrated in FIGS. 2-7) arranged coaxially about a common axis. The inner roller may include first powder-passing openings, and the outer roller may include second powder-passing openings. The outer roller may be spaced from the inner roller to define an annular powder-transfer region (e.g., a small gap between the rollers). During operation, relative rotation between the inner roller and the outer roller may move powder through the annular powder-transfer region, generate shear within the annular powder-transfer region, and dispense powder through the second powder-passing openings (e.g., apertures) of the outer roller toward a surface of the substrate 110.

The powder coating system 100 may include a second powder dispersion apparatus 113 positioned at another location along the substrate transport path. The second powder dispersion apparatus 113 may be configured similarly to the first powder dispersion apparatus 112. The first and second powder dispersion apparatuses 112, 113 may be positioned and/or configured to dispense powder onto the same surface of the substrate 110 at different locations, onto opposite surfaces of the substrate 110, or both, depending on the routing of the substrate 110 through the housing 102. In some embodiments, the first and second powder dispersion apparatuses 112, 113 may be vertically opposed, horizontally opposed, staggered, offset, or arranged at different angles relative to the substrate transport path.

The first and second powder dispersion apparatuses 112, 113 may be operated together or independently. For example, the first and second powder dispersion apparatuses 112, 113 may be operated together to coat both surfaces of the substrate 110, or one of the first and second powder dispersion apparatuses 112, 113 may be operated while the other is idle to coat only one surface of the substrate 110. In some embodiments, the first and second powder dispersion apparatuses 112, 113 may be independently driven, loaded, or controlled. As a result, the powder coating system 100 may apply the same powder to different surfaces of the substrate 110, different powders to different surfaces of the substrate 110, different coating weights to different surfaces of the substrate 110, or powder to only one surface of the substrate 110.

The powder supplied to the first and/or second powder dispersion apparatuses 112, 113 may include any powder suitable for the substrate 110 and intended coating. In some embodiments, the powder may include a carbonaceous powder, ceramic powder, polymer powder, lithium-ion-conducting powder, electronically conductive powder, protective powder, solid electrolyte powder, surface-treatment powder, or a mixture thereof. In embodiments in which the substrate 110 includes lithium metal foil or another battery-related substrate, the powder may be configured to form a functional interface layer or other surface treatment on the substrate 110. Non-limiting examples of such functional powders include carbon black, graphite, graphene, carbon nanotubes, ceramic particles, oxide particles, sulfide particles, phosphate particles, polymer particles, solid electrolyte particles, lithium-ion-conducting particles, or combinations thereof. In some embodiments, when the substrate 110 includes lithium metal foil, the powder coating may improve handling, interface stability, electrolyte interaction, protective layer formation, cycling behavior, or other battery-related characteristics.

The powder coating system 100 may include one or more powder brushes, including powder brushes 108 and 116. The powder brushes 108, 116 may be positioned adjacent to the substrate transport path, adjacent to a corresponding powder dispersion apparatus 112, 113, or both. In one example, a powder brush may comprise a circular silicone brush mounted to rotate about an axis parallel to an axis of a corresponding outer roller. The powder brushes 108, 116 may distribute, level, spread, remove, or otherwise condition powder dispensed onto the substrate 110. In some embodiments, a powder brush may remove excess powder from the substrate 110, level deposited powder, spread powder laterally, break local powder accumulations, clean an outer roller surface, and/or transfer powder from an outer roller surface toward the substrate 110. A powder brush may include silicone, polymer, elastomer, fiber, carbon, metal, ceramic, foam, flocked, or other bristle materials. The number, position, angle, contact pressure, rotational direction, and speed of the powder brushes 108, 116 may be adjustable.

The powder coating system 100 may also include one or more additional powder brush attachment points 106. The additional powder brush attachment points 106 may allow supplemental powder brushes or other powder-distribution components to be installed at selected positions along the substrate transport path. For example, additional powder brushes may be used to improve powder distribution, remove excess powder, condition a coated surface, or adapt the powder coating system 100 for different substrates, powders, coating weights, or coating recipes.

The housing 102 may include one or more powder collection features, such as powder collection shelves 104. In the illustrated embodiment, a first powder collection shelf 104 is positioned in a lower portion of the housing 102, and a second powder collection shelf is positioned below a coating region associated with one or more of the powder dispersion apparatuses 112, 113. The powder collection shelves 104 may receive powder that is not deposited on the substrate 110 or that is removed from the substrate 110 by one or more powder brushes 108, 116. Collected powder may be discarded, analyzed, sieved, dried, recycled, returned to a powder feed system, or otherwise handled. In other embodiments, a powder collection feature may include a tray, trough, removable drawer, funnel, vacuum port, recovery chamber, or combinations thereof.

In some embodiments, the powder coating system 100 may include one or more electrostatic charging units 150. An electrostatic charging unit(s) 150 may apply charge to powder within a powder dispersion apparatus 112, 113, to powder exiting an outer roller, to the substrate 110, to a backing roller, to a powder brush 108, 116, or to an electrode positioned near a coating zone. In some embodiments, the level and/or amount of the electric charge applied by charging units 150 can be controlled by a controller 140 (described in greater detail below) either by a wired or wireless connection. Notably, controller 140 permits a user to manage and monitor the electrostatic charge that is applied to the substrate or the powder. Electrostatic assistance may bias powder toward the substrate 110, reduce powder drift, improve coating efficiency, or enable pattern control. The electrostatic charging unit may operate continuously, intermittently, or according to a feedback signal. Electrostatic parameters may be adjusted together with mechanical parameters, such as roller speed or substrate speed. In some embodiments, grounding connections or static-dissipative components may be used to control charge accumulation within the housing 102.

In some embodiments, the powder coating system 100 may include a controller 140 configured to operate or coordinate one or more components of the system 100. The controller 140 may include a programmable logic controller, microcontroller, industrial computer, motor controller, software system, or combinations thereof. For example, the controller 140 may operate motors, powder feed mechanisms, electrostatic charging units 150, powder brushes 108, 116, guide rollers 114, environmental controls, or other components. The controller 140 may receive inputs from one or more sensors, such as substrate speed sensors, tension sensors, powder level sensors, torque sensors, motor current sensors, optical sensors, laser thickness sensors, mass sensors, cameras, humidity sensors, oxygen sensors, pressure sensors, vibration sensors, electrostatic sensors, or combinations thereof. Based on one or more sensor inputs, the controller 140 may adjust roller speeds, roller speed ratios, powder feed rates, powder brush speeds, electrostatic voltages, substrate speed, collection settings, or environmental conditions.

In some embodiments, the controller may implement a coating recipe (e.g., operating parameters) for a selected powder and substrate 110. The coating recipe may specify one or more operating parameters, such as aperture configuration (e.g., powder-passing opening configuration), radial gap dimension, inner roller speed, outer roller speed, relative rotational speed, speed ratio, substrate speed, powder feed rate, powder brush pressure, powder brush speed, electrostatic voltage, target coating weight, or process limits. Feedback control may be used to maintain coating uniformity. For example, an optical inspection system, mass sensor, or thickness sensor may detect a coating condition of the substrate 110, and the controller may adjust one or more operating parameters in response.

In operation, the substrate 110 may be conveyed through the housing 102 along the substrate transport path using the guide rollers 114. Powder may be supplied to one or more of the powder dispersion apparatuses 112, 113. Relative rotation between the inner and outer rollers of each powder dispersion apparatus 112, 113 moves powder through the corresponding annular powder-transfer region, generates shear within the annular powder-transfer region, and dispenses the powder through openings of the corresponding outer roller. The dispensed powder is deposited onto the substrate 110, and one or more powder brushes 108, 116 may distribute or level the deposited powder. Excess powder may be collected by the powder collection shelves 104. In some embodiments, the coated substrate 110 may thereafter be subjected to post-deposition conditioning, such as calendaring, pressing, heating, cooling, laminating, electrostatic neutralization, vibration, gas flow, vacuum removal, optical inspection, mass measurement, thickness measurement, electrochemical impedance spectroscopy, other in-line characterization, or feedback-based control, either within the housing 102 or downstream in a roll-to-roll line.

FIG. 2 illustrates an example powder dispersion apparatus 200 according to some embodiments. The powder dispersion apparatus 200 may correspond to one or more of the powder dispersion apparatuses described with respect to FIG. 1. The powder dispersion apparatus 200 includes an inner roller 202 and an outer roller 204 arranged coaxially about a common axis. The outer roller 204 is disposed around the inner roller 202 and may be spaced from the inner roller 202 to define an annular powder-transfer region between the inner roller 202 and the outer roller 204.

The inner roller 202 may include a plurality of first powder-passing openings, and the outer roller 204 may include a plurality of second powder-passing openings. Powder introduced into the powder dispersion apparatus 200 may be delivered through the powder inlet 210 into an interior chamber of the inner roller 202, pass through the first powder-passing openings of the inner roller 202, move through the annular powder-transfer region, and be dispensed through the second powder-passing openings of the outer roller 204. In some embodiments, the second powder-passing openings of the outer roller 204 may provide a final metering stage for powder dispensed from the powder dispersion apparatus 200. The first powder-passing openings and the second powder-passing openings may be circular, oval, slotted, polygonal, tapered, countersunk, laser-drilled, chemically etched, mechanically drilled, punched, or otherwise formed.

The powder dispersion apparatus 200 may include one or more internal structures 206. The internal structures 206 may include ribs, vanes, supports, or other powder-directing structures. In some embodiments, the internal structures 206 may extend radially, longitudinally, helically, circumferentially, or in combinations thereof. The internal structures 206 may maintain concentricity between the inner roller 202 and the outer roller 204, support one or more roller walls, increase mechanical rigidity, agitate powder, distribute powder axially, or assist metering of powder through the powder-passing openings.

The powder dispersion apparatus 200 may include a powder inlet 210 configured to receive powder into the powder dispersion apparatus 200. In FIG. 2, the powder inlet 210 is located at a distal end of the powder dispersion apparatus 200 and may deliver powder into an interior chamber of the inner roller 202. In some embodiments, powder may be loaded through the powder inlet 210 while the powder dispersion apparatus 200 is stationary and then retained within the powder dispersion apparatus 200 during operation. In other embodiments, powder may be fed continuously or semi-continuously through the powder inlet 210 using a feed tube, auger, vibratory feeder, hopper, cartridge, pneumatic feed, metered powder delivery system, or other powder feed arrangement. The powder inlet 210 may communicate with the interior chamber of the inner roller 202, the annular powder-transfer region, or both.

The powder dispersion apparatus 200 may include a motorized end 208. The motorized end 208 may be coupled to a motor, gearbox, belt, magnetic coupling, drive shaft, or other drive mechanism for rotating one or both of the inner roller 202 and the outer roller 204. In some embodiments, the drive mechanism may rotate the inner roller 202 and the outer roller 204 independently, at different rotational speeds, in opposite rotational directions, or in the same rotational direction at different speeds. In other embodiments, one of the inner roller 202 or the outer roller 204 may be held stationary while the other rotates.

During operation, powder may be introduced through the powder inlet 210 and moved within the powder dispersion apparatus 200 by relative rotation between the inner roller 202 and the outer roller 204. The relative rotation may move powder through the annular powder-transfer region, generate shear within the annular powder-transfer region, and dispense powder through the second powder-passing openings of the outer roller 204. Powder may be lifted, sheared, circulated, compressed, or loosened by roller rotation, by the internal structures 206, or both. The shear may de-agglomerate powder within the annular powder-transfer region before the powder is dispensed from the outer roller 204. In some embodiments, powder may pass through aligned or partially aligned powder-passing openings of the inner roller 202 and the outer roller 204. Relative angular positions of the first powder-passing openings and the second powder-passing openings may define a time-varying powder flow path that meters powder delivery or reduces uncontrolled powder discharge. In some embodiments, powder may exit the outer roller 204 in a downward, upward, tangential, radial, or angled direction toward the substrate. A guide, shield, chute, baffle, air curtain, electric field, grounded plate, or other directing feature may be used to direct powder toward an intended surface of the substrate or reduce stray powder. The powder dispersion apparatus 200 may thereby meter powder and dispense powder toward a substrate positioned adjacent to the outer roller 204.

FIG. 3 illustrates a side view of the powder dispersion apparatus 200 of FIG. 2, according to some embodiments. As shown, the powder dispersion apparatus 200 includes the outer roller 204 extending between a first end 304 and a motorized end 208. The outer roller 204 may include a plurality of second powder-passing openings distributed along a length of the outer roller 204. The second powder-passing openings may be arranged in rows, columns, staggered patterns, or other opening patterns selected to dispense powder through the outer roller 204.

In the illustrated embodiment of FIG. 3, the motorized end 208 is positioned at one end of the powder dispersion apparatus 200 and may be coupled to a motor, gearbox, belt, magnetic coupling, drive shaft, or other drive mechanism. The drive mechanism may rotate one or both of the inner roller 202 and the outer roller 204 to establish relative rotation between the inner roller 202 and the outer roller 204. The first end 304 may comprise a rolling end, powder insertion end, support end, end cap, bearing end, alignment component, sealing component, or other end component configured to support, close, align, seal, or provide access to the powder dispersion apparatus 200.

In some embodiments, the outer roller 204 may have an axial length of about 279.4 mm. The first end 304, the motorized end 208, or both may have an example axial thickness or end spacing of about 25.4 mm, as shown. These dimensions are examples only, and other lengths, end dimensions, roller diameters, opening sizes, or opening patterns may be used based on the powder, substrate, desired coating width, desired powder throughput, and other operating conditions.

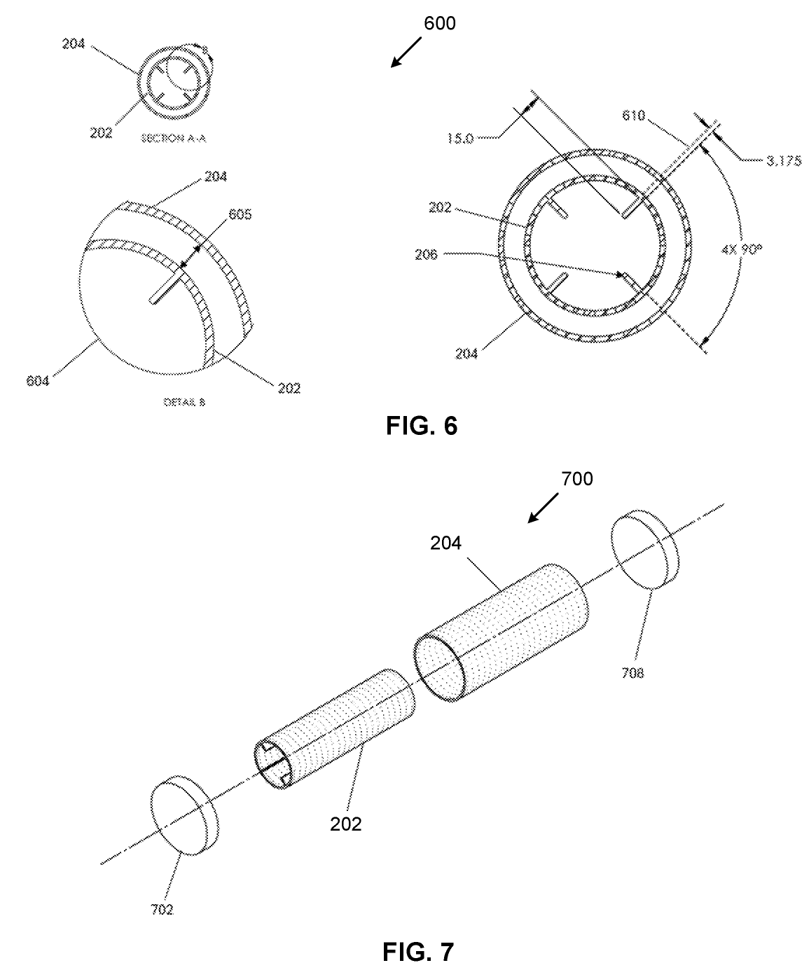

FIG. 3 also identifies a sectional line A-A through the powder dispersion apparatus 200. Section A-A may correspond to a sectional view of the inner roller 202, outer roller 204, annular powder-transfer region, and one or more internal structures shown and described with respect to FIG. 6. The sectional view may further illustrate the coaxial arrangement of the inner roller 202 and outer roller 204 and the spacing between them that defines the annular powder-transfer region.

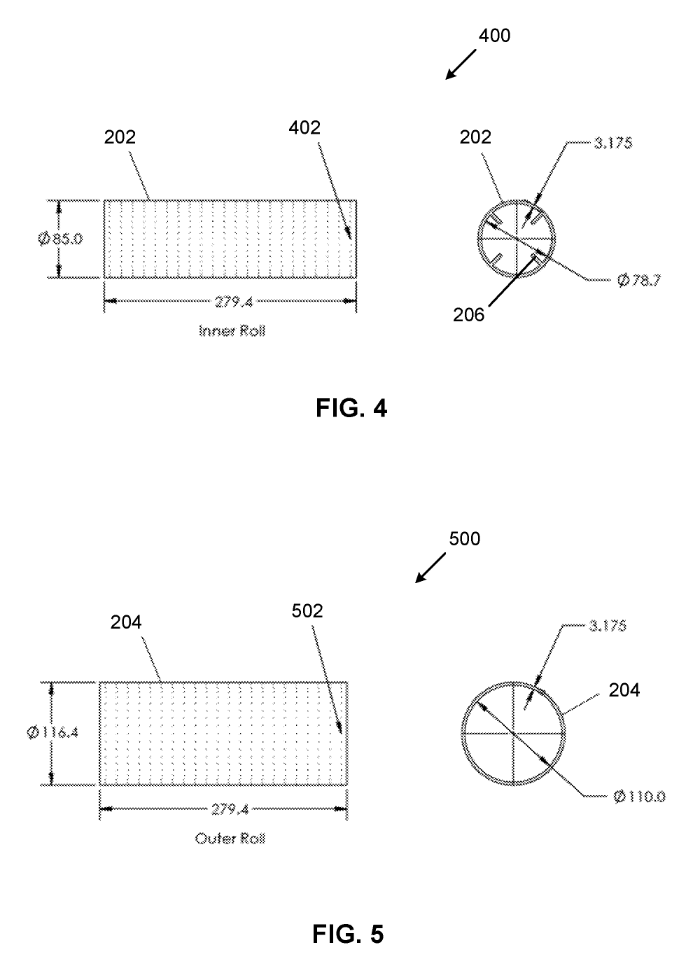

FIG. 4 illustrates an example inner roller 202 of the powder dispersion apparatus 200 according to some embodiments. The inner roller 202 may be arranged coaxially within an outer roller, such as the outer roller 204 described with respect to FIGS. 2 and 3. The inner roller 202 may be configured to receive powder in its interior chamber and to pass the powder outwardly through a plurality of first powder-passing openings 402.

As shown, the first powder-passing openings 402 may be distributed along a cylindrical wall of the inner roller 202. The first powder-passing openings 402 may be arranged in rows, columns, staggered patterns, or other patterns selected to control powder flow from the interior chamber of the inner roller 202 toward an annular powder-transfer region defined between the inner roller 202 and the outer roller. In some embodiments, the number, size, spacing, and pattern of the first powder-passing openings 402 may be selected based on powder particle size distribution, target coating weight, desired powder throughput, roller diameter, or other operating parameters. In some embodiments, the inner roller 202, the outer roller 204, or both may include hundreds of powder-passing openings distributed along a roller length. For example, a roller may include about 440 openings, about 880 openings, or another number selected based on roller length, desired powder flow, and substrate width. In some embodiments, opening diameters for the inner roller may range from about 20 micrometers to about 500 micrometers.

In FIG. 4, the inner roller 202 has an example axial length of about 279.4 mm and an example outer diameter of about 85.0 mm. The inner roller 202 may also have an example inner diameter of about 78.7 mm. These dimensions are examples only, and other lengths, diameters, wall thicknesses, opening sizes, and opening patterns may be used.

The inner roller 202 may include one or more internal structures 206 positioned within the interior chamber of the inner roller 202. The internal structures 206 may include ribs, vanes, supports, spokes, reinforcing features, or other powder-directing structures. The internal structures 206 may extend radially, longitudinally, helically, circumferentially, or in combinations thereof. In the illustrated embodiment (which shows the side view of the inner roller), the internal structures 206 extend inwardly from the cylindrical wall of the inner roller 202. The wall of inner roller 202 may have an example thickness of about 3.175 mm as shown in FIG. 4.

The internal structures 206 may maintain circularity of the inner roller 202, resist torsional deformation during rotation, maintain concentric alignment between the inner roller 202 and the outer roller, support the cylindrical wall of the inner roller 202, agitate powder within the inner roller 202, distribute powder axially, or assist metering of powder through the first powder-passing openings 402. During operation, powder may be introduced into the interior chamber of the inner roller 202, moved by rotation of the inner roller 202, and passed through the first powder-passing openings 402 toward the annular powder-transfer region.

FIG. 5 illustrates an example outer roller 204 of the powder dispersion apparatus 200, according to some embodiments. The outer roller 204 may be arranged and/or positioned around an inner roller, such as the inner roller 202 described in FIG. 4. The outer roller 204 and the inner roller 202 may be arranged coaxially about a common axis, and the outer roller 204 may be spaced from the inner roller 202 to define an annular powder-transfer region.

The outer roller 204 may include a plurality of second powder-passing openings 502 distributed along a cylindrical wall of the outer roller 204. The second powder-passing openings 502 may be arranged in rows, columns, staggered patterns, or other patterns selected to control powder flow from the annular powder-transfer region through the outer roller 204. In some embodiments, the number, size, spacing, and pattern of the second powder-passing openings 502 may be selected based on powder particle size distribution, target coating weight, desired powder throughput, roller diameter, substrate width, or other operating parameters.

In some embodiments, the second powder-passing openings 502 of the outer roller 204 may provide a final metering stage for powder dispensed from the powder dispersion apparatus 200. For example, at least some of the second powder-passing openings 502 may be smaller than at least some of the first powder-passing openings 402 of the inner roller 202. In one illustrated example, the first powder-passing openings 402 of the inner roller 202 may have a diameter of about 0.100 mm (100 micrometers), and the second powder-passing openings 502 of the outer roller 204 may have a diameter of about 0.050 mm (i.e., 50 micrometers). Other opening sizes may be used depending on the powder, desired powder flow rate, and coating conditions. For example, in some embodiments, opening diameters for the outer roller may range from about 5 micrometers to about 100 micrometers.

In the illustrated embodiment, the outer roller 204 has an example axial length of about 279.4 mm and an example outer diameter of about 116.4 mm. The outer roller 204 may also have an example inner diameter of about 110.0 mm (as shown in the side view of the outer roller). The illustrated outer roller 204 may have a wall thickness of about 3.175 mm. These dimensions are examples only, and other lengths, diameters, wall thicknesses, opening sizes, and opening patterns may be used.

During operation, powder may be received in the annular powder-transfer region between the inner roller 202 and the outer roller 204. Relative rotation between the inner roller 202 and the outer roller 204 may move the powder through the annular powder-transfer region, generate shear within the annular powder-transfer region, and dispense the powder through the second powder-passing openings 502 of the outer roller 204. The shear may de-agglomerate powder within the annular powder-transfer region before the powder exits through the second powder-passing openings 502. The outer roller 204 may thereby cooperate with the inner roller 202 to meter and dispense powder toward a substrate positioned adjacent to the outer roller 204.

FIG. 6 illustrates sectional and detail views of a portion of the powder dispersion apparatus 200, according to some embodiments. In particular, FIG. 6 includes a sectional view 602 taken along section line A-A of FIG. 3 and a detail view “B” 604 showing an enlarged portion of the relationship between the inner roller 202 and the outer roller 204 (shown in section view 602).

As shown in the sectional view 602 (of section A-A), the inner roller 202 may be disposed within the outer roller 204 and arranged coaxially with the outer roller 204 about a common axis. The outer roller 204 may be spaced from the inner roller 202 to define an annular powder-transfer region or gap 605. During operation, powder may pass from an interior chamber of the inner roller 202, through first powder-passing openings of the inner roller 202, into the annular powder-transfer region 605, and then through second powder-passing openings of the outer roller 204.

The annular powder-transfer region 605 may provide a controlled powder-transfer volume between the inner roller 202 and the outer roller 204. Relative rotation between the inner roller 202 and the outer roller 204 may move powder through the annular powder-transfer region 605, generate shear within the annular powder-transfer region 605, and dispense powder through the outer roller 204. In some embodiments, the shear may de-agglomerate powder, reduce bridging at powder-passing openings, and promote more uniform powder delivery through the outer roller 204. The size of the annular powder-transfer region 605 may be selected based on one or more characteristics of the powder or coating process, including powder particle size distribution, particle morphology, desired powder throughput, opening size, or target coating weight. In some embodiments, the annular powder-transfer region 605 may have a radial gap dimension of about one micrometer to about 50 micrometers, depending on average powder particle size, powder morphology, and desired throughput.

The inner roller 202 may include one or more internal structures 206 positioned within the interior chamber of the inner roller 202. The internal structures 206 may include ribs, vanes, supports, spokes, reinforcing features, or other powder-directing structures. In the illustrated embodiment, the internal structures 206 are arranged around the interior of the inner roller 202 and may be spaced at approximately 90-degree intervals. For example, the internal structures 206 may include four internal structures 206 arranged approximately 90 degrees apart from one another. In some embodiments, each internal structure 206 may have an example length of about 15.0 mm and an example thickness of about 3.175 mm (shown with thickness 610). In other embodiments, the internal structures 206 may have different numbers, positions, spacings, lengths, thicknesses, or orientations.

The internal structures 206 may maintain circularity of the inner roller 202, resist torsional deformation during rotation, maintain concentric alignment between the inner roller 202 and the outer roller 204, support a cylindrical wall of the inner roller 202, agitate powder within the inner roller 202, distribute powder axially, or assist metering of powder through the powder-passing openings. In some embodiments, the internal structures 206 may extend radially, longitudinally, helically, circumferentially, or in combinations thereof.

The detail view 604 further illustrates the spacing between the inner roller 202 and the outer roller 204. In some embodiments, this spacing corresponds to the annular powder-transfer region 605. The annular powder-transfer region 605 may be fixed or adjustable, and may be selected to promote controlled powder flow, powder metering, and de-agglomeration as powder moves between the inner roller 202 and the outer roller 204. In some embodiments, the annular powder-transfer region 605 may be adjusted using shims, eccentric mounts, precision bearings, compliant supports, adjustable end caps, or combinations thereof.

FIG. 7 illustrates an exploded view of an example powder dispersion apparatus 700 according to some embodiments. The powder dispersion apparatus 700 may correspond to the powder dispersion apparatus 200 described with respect to FIGS. 2-6 and may include an inner roller 202, an outer roller 204, a first end component 702, and a second end component 708.

As shown, the outer roller 204 is configured to be disposed around the inner roller 202 such that the inner roller 202 and the outer roller 204 are arranged coaxially about the common axis. When assembled, the outer roller 204 may be spaced from the inner roller 202 to define an annular powder-transfer region between the inner roller 202 and the outer roller 204.

The inner roller 202 may include a plurality of first powder-passing openings, and the outer roller 204 may include a plurality of second powder-passing openings. Powder introduced into the powder dispersion apparatus 700 may pass through the first powder-passing openings of the inner roller 202, move through the annular powder-transfer region, and be dispensed through the second powder-passing openings of the outer roller 204.

The first end component 702 may be positioned at a first end of the powder dispersion apparatus 700. In some embodiments, the first end component 702 may comprise a powder coating end, rolling end, end cap, bearing support, sealing component, alignment component, or other end structure configured to support, close, align, or retain one or more portions of the powder dispersion apparatus 700. The first end component 702 may be removable in some embodiments to permit loading, cleaning, replacement, inspection, or servicing of the inner roller 202, the outer roller 204, or other components.

The second end component 708 may be positioned at a second end of the powder dispersion apparatus 700 opposite the first end component 702. In some embodiments, the second end component 708 may comprise a motor end, motorized end, end cap, coupling component, bearing support, sealing component, alignment component, or other end structure. The second end component 708 may be configured to couple the inner roller 202, the outer roller 204, or both to a drive mechanism, such as a motor, gearbox, belt, magnetic coupling, drive shaft, or other drive mechanism.

When assembled, the first and second end components 702, 708 may help maintain alignment of the inner roller 202 and the outer roller 204, support rotation of one or both rollers, retain powder within the powder dispersion apparatus 700, or permit disassembly for cleaning or maintenance. In some embodiments, one or both of the first and second end components 702, 708 may include or cooperate with bearings, bushings, seals, O-rings, gaskets, retaining rings, coupling features, or alignment features.

The exploded view of FIG. 7 illustrates one example arrangement in which the inner roller 202 is received within the outer roller 204 and the first and second end components 702, 708 are positioned along the common axis. The illustrated arrangement is exemplary, and other end structures, coupling arrangements, sealing arrangements, or assembly configurations may be used.

The inner roller 202, the outer roller 204, the first end component 702, the second end component 708, or other components of the powder dispersion apparatus 700 may be formed from materials selected for compatibility with the powder and substrate. Example materials include stainless steel, aluminum, nickel alloys, titanium, polymer composites, ceramics, coated metals, anti-static materials, non-sparking materials, chemically compatible materials, or combinations thereof. Surface finishes may be selected to control powder adhesion, cleanability, or wear.

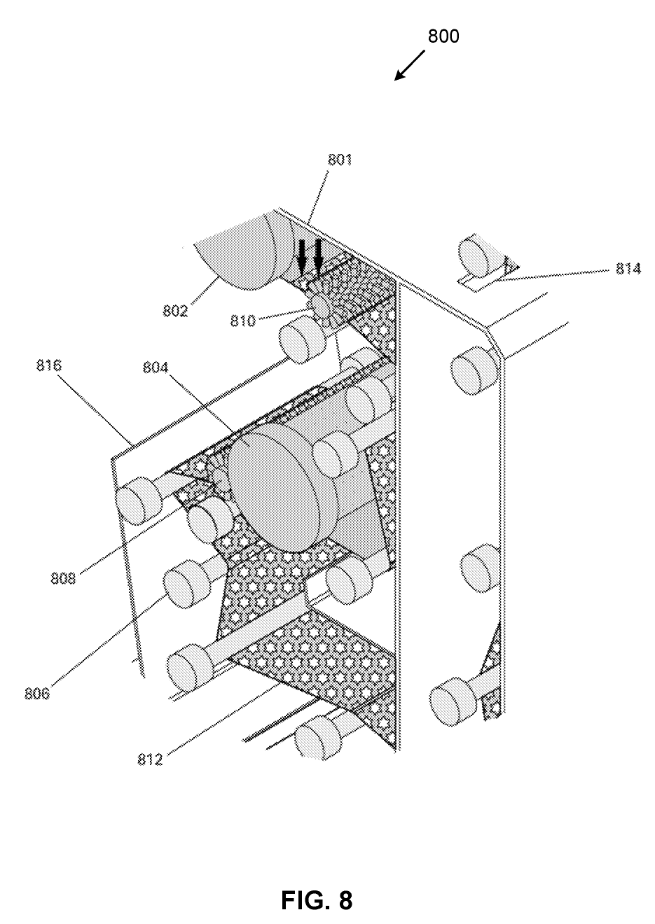

FIG. 8 illustrates a perspective view of an example roll-to-roll powder coating system 800 according to some embodiments. The powder coating system 800 may include features the same as, or similar to, the powder coating system 100 described with respect to FIG. 1. In the illustrated embodiment, the powder coating system 800 includes a housing 801, a first powder dispersion apparatus 802, a second powder dispersion apparatus 804, guide rollers 806, powder brushes 808, 810, a substrate 812, an exit point 814, and one or more powder collection shelves 816.

The perspective view of FIG. 8 illustrates one example spatial arrangement of the first and second powder dispersion apparatuses 802, 804 relative to the substrate 812 and the guide rollers 806. The substrate 812 may be routed through the housing 801 along a substrate transport path and may exit the housing 801 at the exit point 814. The first and second powder dispersion apparatuses 802, 804 may dispense powder toward the substrate 812 as described above with respect to the powder dispersion apparatuses 112, 113 of FIG. 1. The powder brushes 808, 810 may distribute or level powder deposited on the substrate 812, and the powder collection shelf 816 may collect excess powder within the housing 801.

As shown in FIG. 8, the perspective view may further illustrate the relative placement of powder dispensing, brushing, substrate routing, and powder collection components within the housing 801. The particular arrangement shown is illustrative, and other positions, orientations, numbers, or combinations of powder dispersion apparatuses, guide rollers, powder brushes, and powder collection features may be used.

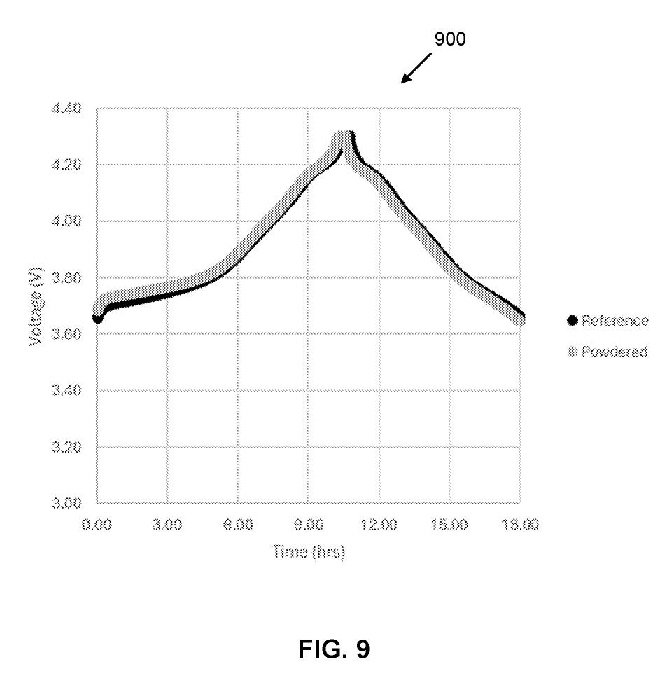

FIG. 9 illustrates a graph 900 depicting voltage as a function of time for a single formation cycle of electrochemical cells, according to some embodiments. In the illustrated embodiment, the graph 900 compares a reference lithium metal coin cell with a lithium metal coin cell having powder applied using concentric rollers.

As shown in FIG. 9, the horizontal axis represents time in hours, and the vertical axis represents voltage. The graph 900 includes a reference curve and a powdered-cell curve. The powdered-cell curve corresponds to the lithium metal coin cell having powder applied using concentric rollers. FIG. 9 illustrates example electrochemical formation-cycle data associated with use of the powder dispersion apparatuses and systems described herein. The voltage curves shown in graph 900 are examples only and are not intended to limit the powder dispersion apparatuses, powder coating systems, substrates, powders, or methods described herein.

Regarding FIG. 9, graph 900 compares the battery formation profiles of two cells, one cell with powder coating applied through the concentric rollers and one cell without powder coating. Since the formation cycle is performed at a very slow charge rate, minimal electrochemical or structural variation is expected during this step. The results confirm that both cells completed the formation cycle successfully and displayed nearly identical voltage profiles, indicating that the powder coating process using the concentric rollers did not adversely affect the initial formation behavior.

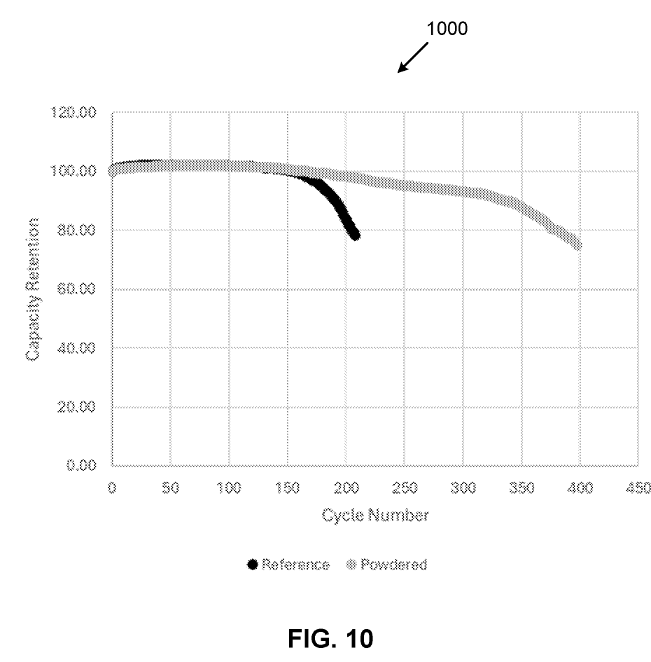

FIG. 10 illustrates a graph 1000 depicting capacity retention as a function of cycle number for electrochemical cells, according to some embodiments. In the illustrated embodiment, the graph 1000 compares a reference lithium metal coin cell with a lithium metal coin cell having powder applied using concentric rollers.

As shown in FIG. 10, the horizontal axis represents cycle number, and the vertical axis represents capacity retention. The graph 1000 includes a reference curve and a powdered-cell curve. The powdered-cell curve corresponds to the lithium metal coin cell having powder applied using concentric rollers. For long term cycling, the cell containing the powder coated electrode demonstrates significantly improved capacity retention compared with the reference cell. As shown in FIG. 10, the reference cell begins to experience accelerated capacity decay after approximately 170 cycles and drops rapidly thereafter. By contrast, the powder coated cell maintains a slower and more controlled capacity fade over nearly 400 cycles.

This improvement suggests that the powder coating introduced through the concentric roller process provides beneficial interfacial stabilization during cycling. The coating may function as a protective surface modifying layer that promotes the development of a more stable solid electrolyte interphase, reduces parasitic reactions between the electrode and electrolyte, and mitigates localized current concentration. These effects can help preserve active lithium inventory, reduce impedance growth, and maintain more uniform electrochemical reactions across the electrode surface. Consequently, the powder coated electrode shows enhanced cycling stability and superior long term battery performance relative to the uncoated reference cell.

FIG. 10 illustrates example capacity-retention data associated with use of the powder dispersion apparatuses and systems described herein. The capacity-retention curves shown in graph 1000 are examples only and are not intended to limit the powder dispersion apparatuses, powder coating systems, substrates, powders, or methods described herein.

In some embodiments, a method of powder coating may include providing a substrate, loading powder into a powder dispersion apparatus, establishing relative rotation between an inner roller and an outer roller, generating shear-induced powder flow through powder-passing openings of the inner and outer rollers, dispensing powder from the outer roller onto the substrate, and moving the substrate relative to the powder dispersion apparatus. The method may further include selecting a radial gap dimension, opening diameter, opening density, opening pattern, relative rotational speed, and substrate speed based on a target coating weight or coating uniformity. The method may further include brushing the coated substrate, removing excess powder using a brush or vacuum, collecting excess powder, measuring coating uniformity, and adjusting one or more operating parameters in response to a measured coating condition.

Although particular embodiments, dimensions, process sequences, and example geometries have been described herein for purposes of illustration, the disclosed embodiments are not limited to the specific values, shapes, materials, or arrangements shown. The size, shape, spacing, and position of the powder-passing openings may be varied; the inner roller, outer roller, housing, guide rollers, powder brushes, powder collection features, and other components may be selected from a range of suitable materials and configurations; and the powder feed, roller drive, electrostatic charging, environmental control, and feedback-control features may be implemented using different control architectures and processing conditions. Accordingly, the disclosed embodiments are illustrative rather than limiting, and variations may be made without departing from the scope of the present disclosure as defined by the claims.

Furthermore, several implementations have been described. Nevertheless, it will be understood that various modifications may be made without departing from the spirit and scope of the disclosure. Accordingly, other implementations are within the scope of the following claims.

1. A powder dispersion apparatus comprising:
an inner roller comprising a plurality of first powder-passing openings;
an outer roller disposed around the inner roller and comprising a plurality of second powder-passing openings, the inner roller and the outer roller being arranged coaxially about a common axis, the outer roller being spaced from the inner roller to define an annular powder-transfer region; and
a drive mechanism configured to rotate one or both of the inner roller and the outer roller to establish relative rotation between the inner roller and the outer roller;
wherein relative rotation between the inner roller and the outer roller moves powder through the annular powder-transfer region, generates shear within the annular powder-transfer region, and dispenses the powder through the second powder-passing openings of the outer roller.

2. The powder dispersion apparatus of claim 1, wherein the shear de-agglomerates the powder within the annular powder-transfer region prior to the powder being dispensed through the second powder-passing openings of the outer roller.

3. The powder dispersion apparatus of claim 1, wherein the drive mechanism is configured to rotate the inner roller and the outer roller in opposite rotational directions to generate counter-rotational shear within the annular powder-transfer region.

4. The powder dispersion apparatus of claim 1, wherein the annular powder-transfer region has a radial gap dimension ranging between one micrometer and 50 micrometers.

5. The powder dispersion apparatus of claim 1, wherein at least some of the second powder-passing openings are smaller than at least some of the first powder-passing openings such that the second powder-passing openings provide a final metering stage for the powder.

6. The powder dispersion apparatus of claim 1, wherein at least one of the inner roller or the outer roller comprises one or more internal structures extending radially, longitudinally, circumferentially, or helically and configured to maintain concentricity, agitate powder, or distribute powder axially.

7. The powder dispersion apparatus of claim 1, further comprising an electrostatic charging unit configured to apply an electrostatic charge to the powder, to a substrate positioned to receive the powder, or to both.

8. The powder dispersion apparatus of claim 1, further comprising at least one powder brush positioned adjacent to the outer roller, adjacent to a substrate positioned to receive the powder, or both, wherein the at least one powder brush is configured to distribute or level powder dispensed from the outer roller.

9. The powder dispersion apparatus of claim 1, wherein the drive mechanism is configured to independently control each of a rotational speed of the inner roller and a rotational speed of the outer roller to vary a powder dispensing rate through the second powder-passing openings.

10. The powder dispersion apparatus of claim 1, further comprising an axial powder inlet configured to deliver the powder into an interior chamber of the inner roller.

11. A roll-to-roll powder coating system comprising:
a housing configured to maintain a dry or inert atmosphere;
a substrate transport path extending through the housing and configured to convey a substrate;
a plurality of guide rollers arranged to guide the substrate along the substrate transport path; and
a powder dispersion apparatus positioned adjacent to the substrate transport path and configured to dispense powder onto a surface of the substrate, the powder dispersion apparatus comprising an inner roller and an outer roller arranged coaxially about a common axis, the inner roller comprising a plurality of first powder-passing openings, the outer roller comprising a plurality of second powder-passing openings and being spaced from the inner roller to define an annular powder-transfer region, the powder dispersion apparatus being configured to establish relative rotation between the inner roller and the outer roller to move the powder through the annular powder-transfer region, generate shear within the annular powder-transfer region, and dispense the powder through the second powder-passing openings of the outer roller.

12. The roll-to-roll powder coating system of claim 11, wherein the substrate comprises a metal foil substrate.

13. The roll-to-roll powder coating system of claim 12, wherein the metal foil substrate comprises lithium metal foil.

14. The roll-to-roll powder coating system of claim 11, further comprising a second powder dispersion apparatus positioned adjacent to the substrate transport path and configured to dispense powder onto an opposite surface of the substrate.

15. The roll-to-roll powder coating system of claim 14, wherein the powder dispersion apparatus and the second powder dispersion apparatus are independently operable to coat both surfaces of the substrate or to coat only one surface of the substrate.

16. The roll-to-roll powder coating system of claim 14, wherein the powder dispersion apparatus and the second powder dispersion apparatus are independently controllable to apply different powder materials, different coating weights, or both, to opposite surfaces of the substrate.

17. The roll-to-roll powder coating system of claim 11, wherein the powder comprises a carbonaceous powder, a ceramic powder, a polymer powder, a solid electrolyte powder, a lithium-ion-conducting powder, a protective surface-treatment powder, or a combination thereof.

18. The roll-to-roll powder coating system of claim 11, further comprising at least one powder brush positioned adjacent to the substrate transport path and configured to distribute or level powder deposited on the substrate.

19. The roll-to-roll powder coating system of claim 11, further comprising an electrostatic charging unit configured to apply an electrostatic charge to the powder, to the substrate, or to both.

20. The roll-to-roll powder coating system of claim 11, further comprising a controller configured to adjust at least one of a relative rotational speed between the inner roller and the outer roller, a speed of the substrate along the substrate transport path, a powder feed rate, a powder brush speed, or an electrostatic charge applied to the powder or the substrate.
